(19) United States
(12) Patent Application Publication
(10) Pub. No.: US 2026/0232538 A1
(43) Pub. Date: Aug. 13, 2026

(54) INFANT NURSING BOTTLE

(71) Applicant: Williams Sisters Holdings, LLC, O'Fallon, MO (US)

(72) Inventors: Jane M. Molina, O'Fallon, MO (US); Joy M. Williams, Cottleville, MO (US)

(73) Assignee: Williams Sisters Holdings, LLC, O'Fallon, MO (US)

(21) Appl. No.: 19/051,203

(22) Filed: Feb. 12, 2025

(51) Int. Cl. A61J 11/00; A61J 9/00; A61J 11/04

(52) U.S. Cl. CPC A61J 11/005; A61J 9/00; A61J 11/0015; A61J 11/04

(57) ABSTRACT

A baby bottle comprising a bottle, a threaded ring cap, and a nipple, wherein the nipple simulates the natural shape, structure and feel of a mother's breast. The baby bottle of the present invention has a nipple that is made of a relatively soft and pliable material, allowing for a wider and deeper latch, thereby mimicking the feel of breast feeding.

### STATEMENT REGARDING FEDERALLY SPONSORED RESEARCH OR DEVELOPMENT

This invention was made with no government support or sponsorship.

### RELATED PATENT APPLICATIONS AND INCORPORATION BY REFERENCE

Not applicable.

### FIELD OF THE INVENTION

The present invention relates to the field of baby bottles for oral feeding of infants. The bottle of the present invention includes a nipple portion that simulates and mimics the natural shape, structure and consistency of a human mother's breast. The nipple of the bottle provides for the baby to draw the teat and areola portions of the nipple into the mouth in a manner very similar to breast feeding.

### BACKGROUND OF THE INVENTION

Breastfeeding is known to be highly beneficial for both infants as well as mothers. Breast milk is widely considered the best source of nutrition for infants and is believed to help protect infants from short-term and long-term diseases, such as asthma, obesity, type 1 diabetes, and sudden infant death syndrome. Breastfeeding also has health benefits for mothers as well, including reducing the risk of breast and ovarian cancer, type 2 diabetes, and high blood pressure. Furthermore, breastfeeding is a more convenient way for mothers to feed their infant, as breastfeeding can be done anywhere and at any time, without the need to purchase and mix formula, prepare bottles, etc.

However, there are times where circumstances do not permit mothers to breast feed their infants and bottle feeding is the only option. In these instances, mothers may experience some common difficulties with bottle feeding breast milk to their infant. These difficulties may include any one or more of the following: difficulty getting the infant accustomed to bottle feeding; difficulty for the infant to sufficiently draw breast milk from the bottle; “nipple confusion” arising out of the infant being accustomed to feeding from the mother's breast and refusing to take the bottle; and ineffective latching. Consequently, there is a need for an infant bottle that provides a feel similar to a mother's breast, thereby increasing the likelihood of success when transitioning an infant's feeding between the mother's breast and the bottle.

Prior art bottles exist that purport to resemble the feel of a human breast and nipple. However, these prior art bottles have a variety of problems that are not present and are overcome by the present invention.

For example, US. Patent Publ. No. 20150290087 discloses a baby bottle having a lid, a nipple, a collar and a bottle portion. The nipple comprises a base portion and a tip, wherein the nipple is shaped similar to a female human nipple. More specifically, the tip of the nipple is centrally located on the nipple portion and is shaped similar to a female human nipple, comprising ridges or outwardly protruding annular rings therearound, wherein the annular rings are in an ascending configuration and the rings are separated at regular intervals. The interior of the tip comprises spiral ridges that can be felt in the infant's mouth during feeding. However, the disclosed bottle's nipple does not feature the softer, more pliable nipple of the present invention that allows the infant to draw the nipple and areola of the bottle into their mouths in a manner that most closely mimics human breast feeding.

US Patent Publ. No. 20070131637 discloses an artificial nipple for a nursing bottle. The artificial nipple permits close fitting of the nipple to the sucking fossa of an infant while avoiding deformation of the nipple, while providing a form that is similar to a human nipple. The artificial nipple has a nipple top part having at its tip a dispensing hole for dispensing a liquid drink; and an artificial nipple body which is continuous to the nipple top part, and whose diameter and wall thickness are greater than those of the nipple top part. The artificial nipple is made of a flexible material and has a rib, which prevents contact between an upper side and a lower side of the nipple top part when the nipple top part is compressed flat, at an internal surface of a portion where gums of an infant touch as an upper lip of the infant is in contact with the artificial nipple body. However, this artificial nipple does not address drawbacks that are overcome by the nipple of the present invention, which preferably is comprised of two different silicones with varying rigidity for the portion of the nipple between the ring cap and portion entering the infant's mouth. This prior art artificial nipple further lacks the air release hole on the side of the present invention's nipple, allowing air to escape outside the nipple rather than allowing air to enter the infant's mouth.

US Patent Publ. No. 20060011572 discloses a baby bottle nipple having projecting portions adapted to at least partially occlude by a non-circular cross-section. The objective of the disclosed invention in this application is to provide a solution to the problem of air intake into the infant's stomach during feeding from a bottle. The disclosed invention is directed to a nipple that purportedly approximates the shape of an infant's mouth during suckling, inclusive of the corners of the mouth. This application further discloses a nipple having a body with bi-lateral projecting portions. The nipple provides for the infant's mouth to consistently maintain a uniform seal on the nipple, thereby preventing the ingestion of air through the corners of the mouth. The nipple is described as capable of being formed from silicone rubber, but has no mention of the use of silicones of varying rigidity. This disclosure is further silent with regard to a nipple having the shape of a human breast/nipple, does not disclose the particular collapsibility feature of the present invention and does not disclose the use of an air release hole for preventing air from entering the infant's system.

Even with the improvements realized by the above-referenced prior art and other commercially available infant bottles, there still exists a need for a baby bottle that more closely resembles the feel and functionality of a human breast and promotes more effective bottle feeding.

### SUMMARY OF THE INVENTION

The following is a summary of the invention that should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, it is desirable to provide a baby bottle that allows for improved latching and has a softer, more pliable nipple that enables the infant to draw more of the nipple portion into their mouth, creating suction that most closely resembles that of a human mother's breast.

There is described herein, among other things, an embodiment of a baby bottle mimicking the feel of a human mother's breast, the device comprising: a bottle; a threaded ring cap and a nipple. In operation, the nipple is removably affixed to the ring cap and the thread cap, in turn, is attached to the bottle, for example by means of being screwed upon the bottle.

In an embodiment of the baby bottle of the present invention, the nipple comprises a teat portion and an areola portion, wherein the nipple simulates the natural shape, structure and consistency of a mother's breast.

In an embodiment of the baby bottle of the present invention, holes are provided in the teat portion for liquid to pass through. The number and size of said holes are purposed to mimic the volume and flow rate of breast milk experienced while breast feeding.

In an embodiment of the baby bottle of the present invention, the nipple is constructed of a relatively soft and pliable material, such as a soft and pliable silicone, that allows for a wider latch and helps draw more of the bottle into the soft and hard pallets of the infant being fed.

It is therefore an object of the present invention to provide a baby bottle that mimics breast feeding.

It is another object of the present invention to provide a baby bottle that allows a wide and deep latch and oral motor movement and feel that is essential for breast feeding.

It is yet another object of the present invention to provide a baby bottle that allows for a wider latch and, thus, supports improved teeth development.

It is an object of the present invention to provide a baby bottle that permits a wider latch and, thereby, promotes improved jaw alignment and development, tongue development and lip development.

It is still yet another object of the present invention to provide a baby bottle that mimics breast feeding in such a way that helps with speech impairments, promotes healthier sleep habits, and confers a higher likelihood of success when going from bottle feeding to breast feeding.

In light of the foregoing, these and other objects are accomplished in accordance of the principles of the present invention, wherein the novelty of the present invention will become apparent from the following detailed description and claims appended herein.

### BRIEF DESCRIPTION OF THE DRAWINGS

FIG. 1 is a front view of a preferred embodiment of the present invention.

FIG. 2 is a perspective view of a preferred embodiment of the present invention.

FIG. 3 is a perspective disassembled view of an embodiment of the present invention.

FIG. 4 is a perspective view of a nipple of an embodiment of the present invention.

FIG. 5 is a side view of a nipple of an embodiment of the present invention.

FIG. 6 is a top view of a nipple of an embodiment of the present invention

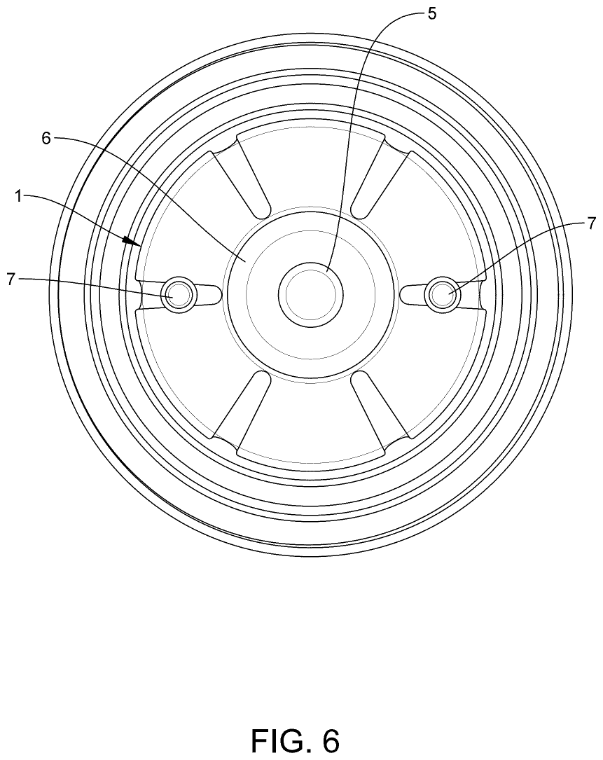

FIG. 7 is a front disassembled view of an embodiment of the present invention.

FIG. 8 is a cross-sectional view of a nipple of a preferred embodiment of the present invention.

### DETAILED DESCRIPTION

The following detailed description is merely exemplary in nature and is not intended to and should not be interpreted to limit the embodiments described herein. Although particular embodiments are described, those embodiments are merely exemplary implementations of the present invention. The following descriptions herein should be considered illustrative in nature, and thus, not in any way limiting the scope of the present invention. One skilled in the art will recognize other embodiments are possible and all such embodiments are intended to fall within the scope of the present disclosure. It is the intent is to include all alternatives, modifications and equivalents that embody the spirit and scope of the disclosure.

It is also to be understood that the disclosure uses terminology for the purpose of describing particular embodiments and such terminology is not intended to be limiting.

Unless defined otherwise, all technical and scientific terms used in this disclosure have the same meaning as commonly understood by one of ordinary skill in the art to which is applicable to this disclosure.

As will be apparent to those of skill in the art upon reading this disclosure, each of the embodiments described herein has discrete components and features which may be readily separated or combined with features of any of the other possible embodiments without departing from the spirit and scope of the present disclosure.

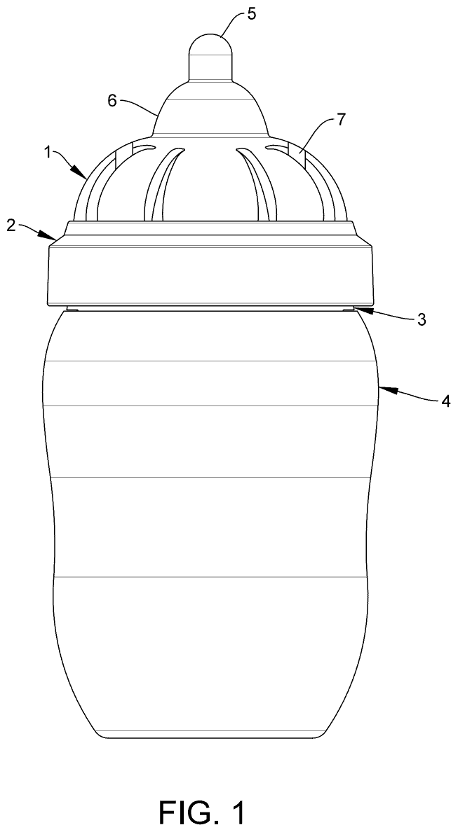

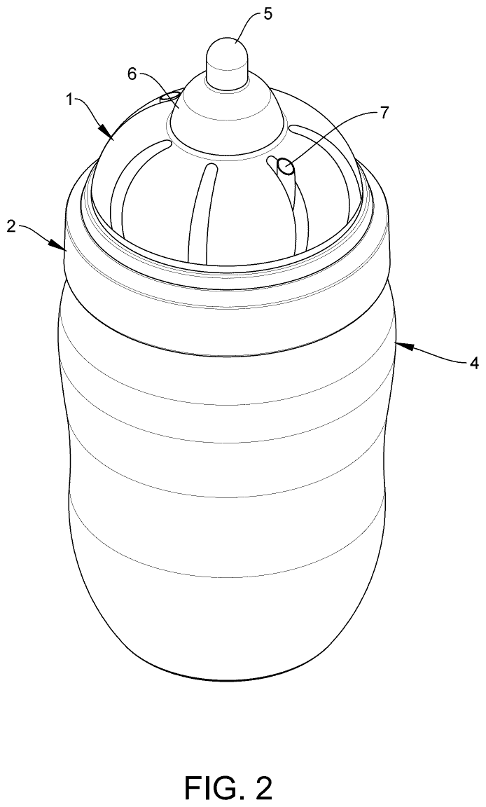

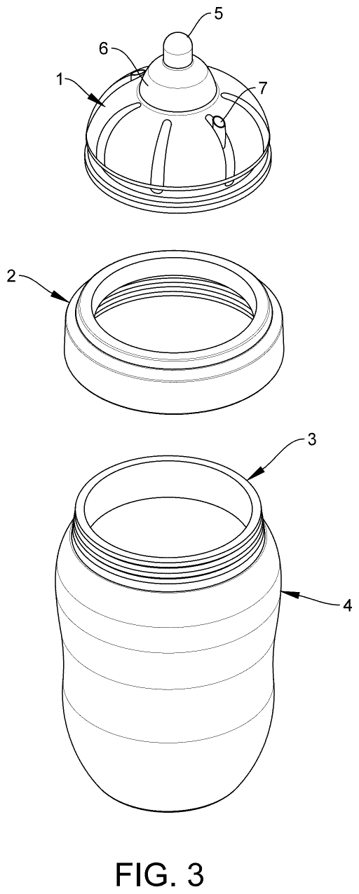

A preferred embodiment of the present invention is shown in FIG. 1-3 and is comprised of a nipple 1, a ring cap 2, and a bottle 3. The bottle 3 is of standard design and comprises a main body 4, which is used to house milk, formula, or another liquid product for feeding an infant. The bottle 3 and ring cap 2 each may be constructed from plastic or a plastic-like material or any other lightweight, rigid material that would be known to be fit for purpose. The nipple 1 comprises a teat portion 5 and an areola portion 6 and generally is shaped, contoured and textured to mimic the feel of a female nipple and breast. As shown in FIGS. 1 and 2, the ring cap 2 functions to attach at its top to the nipple 1 and, likewise, to attach at its opposite bottom to the bottle 3, thus operably connecting the nipple 1 to the bottle 3. The ring cap 2 may be advantageously threaded to engage grooves provided on the lip of the bottle 3, thereby securing the ring cap 2 to the bottle 3. However, the ring cap 2 may otherwise be releasably attached to the bottle 3 by any other means known in the art. Similarly, the ring cap 2 may be configured to receive the nipple 1 and attach thereto by means of snap fit or by any other known suitable means of releasable engagement.

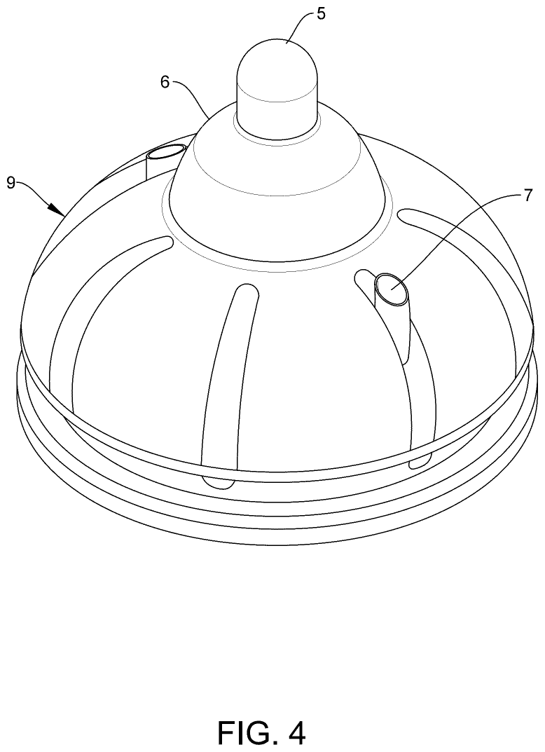

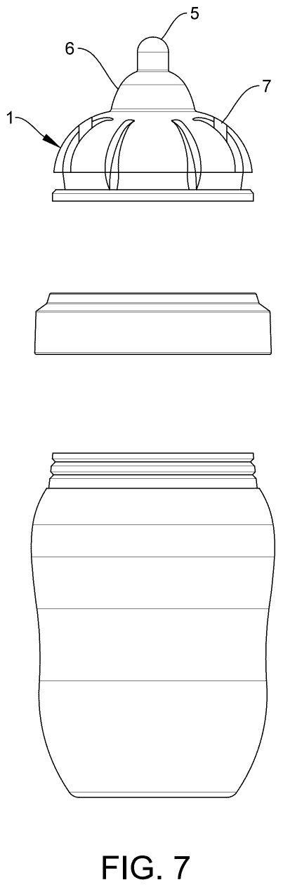

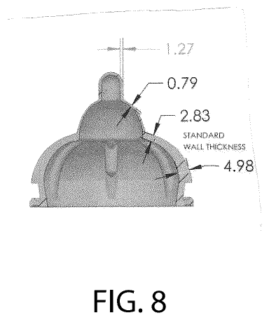

The nipple 1 comprises a teat portion 5 and an areola portion 6, as shown in FIGS. 4 and 7. As illustrated in FIG. 8, the wall thickness of the teat portion 5 is preferably around 1.27 mm and the wall thickness of the areola portion 6 is preferably around 0.79 mm. Accordingly, the ratio of teat portion 5 wall thickness to areola portion 6 wall thickness in an embodiment may preferably be around 1.6 to 1. The nipple 1 will preferably be formed of a relatively soft or flexible and pliable silicone with a durometer softness of about 20. The varying wall thicknesses, as well as the flexibility and pliability of the nipple 1 are all particularly important as they allow for the infant to better draw the teat portion 5 and the areola portion 6 into his or her mouth during feeding, much like the experience of being breast fed. As a result, this wider latch allows for an improved and deeper latch that is conducive to avoiding “nipple confusion” when the infant goes back to nursing from the mother's breast.

The nipple 1 is preferably comprised of a silicone that is highly inert, is not highly reactive with most chemicals, and is suitable for molding. The texture of the nipple 1 mimics the texture of a female human nipple. Moreover, the teat portion 5 and the areola portion 6 of the nipple 1 may be comprised of two different silicones with varying rigidity, thereby enhancing the ability of the nipple 1 to be drawn into the infant's mouth. However, the nipple may otherwise be comprised uniformly of one particular silicone, preferably a medical grade 20 durometer silicone.

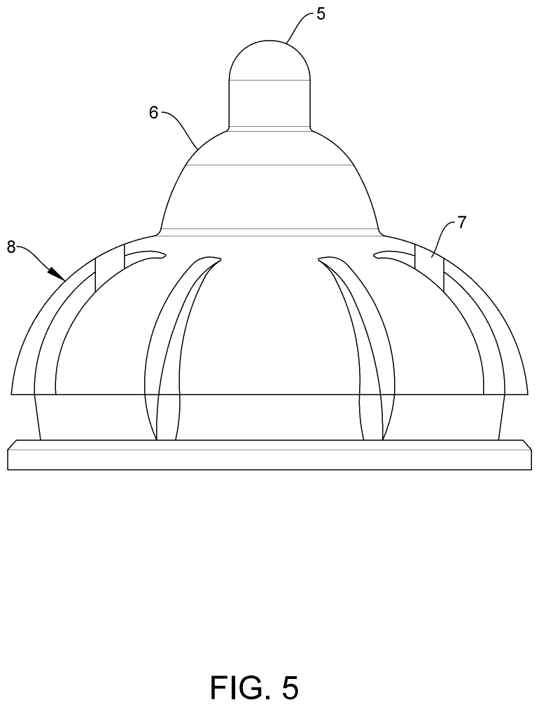

FIG. 4 also shows a nipple 1 of a preferred embodiment of the present invention. Vent holes 7 may also advantageously be provided, as shown in FIG. 4, positioned at opposite ends of the nipple 1. However, vent holes 7 may be otherwise positioned in alternative places on the nipple 1 to aid in equalizing pressure within the interior of the baby bottle of the present invention. Although two vent holes 7 are shown in the preferred embodiment of FIG. 4, any suitable number of vent holes 7 may be employed to attain the desired internal pressure regulation. Moreover, the vent holes 7 allow air to escape outside the nipple rather than allowing air to enter the infant's mouth. Referring to FIGS. 4 and 5, the base portion 8 of the nipple 1 may also advantageously include a plurality of ribs 9. However, other embodiments may not feature any such ribs 9 at all. As illustrated in FIG. 8, the section of the base portion 8 immediately below the areola portion 6 preferably has a wall thickness of around 2.83 mm that gradually increases to around 4.98 mm at or near the section of the base portion 8 that is configured to engage the ring cap 2. Again, the varying wall thickness of the nipple 1 is important to the overall functionality of the nipple 1 mimicking the feel of nursing from a human breast.

The tip of the teat portion 5 of the nipple 1 comprises one or more holes (not shown) through which fluid flows out of the baby bottle of the present invention. The preferable number of holes is in the range of 3 to 5 and the preferred size of said holes is roughly less than 0.8 mm in diameter. The preferred size and number of holes provided in the teat portion 5 of the nipple 1 are purposed to mimic the very unique rate of fluid flow experienced while breast feeding.

Having described the preferred embodiment of the present invention, any number of changes, variations and improvements which may be apparent to those skilled in the art are within the scope of the invention claimed and described herein. As various changes could be made in the above constructions without departing from the scope of the invention, it is intended that all matter contained in the above description or shown in the accompanying drawings shall be interpreted as illustrative and not limiting in any manner.

What is claimed is:

1. A baby bottle, comprising:
a bottle;
a cap ring that is removably attached to said bottle;
a nipple removably attached to said cap ring and having a teat portion and an areola portion, wherein said nipple is comprised of a flexible and pliable material that allows an infant to draw said teat portion and said areola portion into the infant's mouth during feeding.

2. A baby bottle according to claim 1, wherein the teat portion of the nipple has at least one hole that measures less than 0.8 mm in diameter.

3. A baby bottle according to claim 1, wherein the teat portion of the nipple has a plurality of holes.

4. A baby bottle according to claim 3, where the teat portion of the nipple has between 3 to 5 holes.

5. A baby bottle according to claim 1, wherein the nipple is comprised of at least two different materials of varying rigidity.
